(19) United States
(12) Patent Application Publication
(10) Pub. No.: US 2007/0191204 A1
(43) Pub. Date: Aug. 16, 2007

(54) Method for producing a granulate of waste glass, and its use for the manufacture of mineral wool products

(76) Inventors: Matthias Bohrt, Bergisch Gladbach (DE); Peter Schleicher, Altrip (DE); Axel Katzschmann, Schwetzingen (DE); Michael Schumm, Schriesheim (DE)

Correspondence Address: AKERMAN SENTERFITT, P.O. BOX 3188, WEST PALM BEACH, FL, 33402-3188, US

(21) Appl. No.: 10/568,041

(22) PCT Filed: Aug. 12, 2004
(86) PCT No.: PCT/EP04/09059

§ 371 Date: Oct. 6, 2006

(30) Foreign Application Priority Data
Aug. 12, 2003 (DE) 103 37 087.0

(51) Int. Cl. C03C 13/06; B02C 17/02; C03B 37/04

(52) U.S. Cl. 501/36; 65/470; 241/24.3

(57) ABSTRACT

The present invention relates to a method for producing a granulate from waste glass for the manufacture of mineral wool products, such as mineral wool board or mineral wool web, in particular biosoluble glass wool obtained with the aid of at least one spinner having the form of a spinner basket, the peripheral wall of which includes a multiplicity of small-diameter outlet orifices through which a molten glass material is spun off in the form of filaments that are subjected to a supplementary attenuating action of a preferably downwardly directed gas flow, wherein a part of the molten glass material is constituted by glass fragments including foreign matter proportions in a ground form, the granulometry of which is the same size or smaller than the smallest diameter of the outlet orifices in the peripheral wall of the spinner.

The present invention relates to a method for producing a granulate of waste glass for the purposes of manufacturing mineral wool products in accordance with claim 1, as well as a use of the granulate in accordance with claim 10.

Glass is a universal material which—owing to its variegated and variable physical and chemical properties—may be processed into a multiplicity of products, such as, e.g., container glass, flat glass, optical glasses, drinking vessels, dishes, as well as into insulating material for, e.g., thermal and acoustic insulation. At the beginning of the 1940's, a method for manufacturing mineral fibers was developed to this end by the Compagnie de Saint-Gobain, wherein a jet of molten glass was supplied into a drum driven from below and having a perforated annular jacket.

Subsequently this method was improved in that the jet of molten material was guided through a hollow shaft, driven from above, into an annular spinner having the form of a spinner basket, the peripheral jacket of which included a multiplicity of outlet orifices from which the filaments of molten mineral material could homogeneously be guided downwardly into the free space.

Another improvement step consisted in arranging around the spinner basket a so-called “Rapid Burner”, the downwardly directed combustion gases of which attenuate the spun-off primary filaments into fibers, the lengths and finenesses of which satisfy the current high technical demands.

A like apparatus for producing mineral fibers is described in the prior art, e.g., in the French patent specification FR 2 801 301-A1.

During the further process development, spinner baskets were employed which had outlet orifices of various diameters provided in the peripheral jacket. Such a spinner basket for producing mineral fibers is disclosed in the prior art, e.g., in the French patent specification FR 2 820 736-A1.

Another process development is disclosed by patent specification WO 93/02977, which describes the use of a corresponding spinner basket method for the manufacture of rock wool fibers.

Raw materials used for manufacturing mineral fibers are, among others, silica sand, limestone, dolomite, feldspar, igneous rock such as phonolite and basalt, soda and auxiliaries, such as, e.g., refining agents.

The manufacture of mineral fibers herefrom does, however, involve high energy expenditures. Thus vitreous melting of the raw materials at melting temperatures between approx. 1,450° C. and 1,650° C. requires a considerable energy expenditure. About 72% of the energy required for the manufacture of glass products is associated with the melting process.

One possibility of significantly reducing the energy demand for glass melting is the use of waste glass material, in particular in the form of broken glass or powders for the manufacture of mineral fibers.

Finished glass, in particular waste glass, melts at clearly lower temperatures than the raw materials necessary for producing the molten glass material. With each percent of added finished glass, the energy demand is reduced by approx. 0.2 to 0.4%. Moreover the recycling of waste glass results in a reduction of the strain on the environment necessarily involved in the glass melting process (among others CO₂— and NO_{X}—emissions), and reduces the space demand for dumping wastes. The savings of raw materials in connection with the use of waste glass has an additional favorable influence in terms of the environment.

The use of waste glass in the manufacture of mineral wool is, however, not altogether unproblematic. While the use of glass from industrial wastes may take place largely without any problems due to its homogeneity and low impurities, this is not the case with waste glass, for example from collection containers.

While industrial waste glasses generally exhibit a high degree of purity, standard waste glasses are frequently highly contaminated by secondary constituents such as, e.g., bottle caps, clay and ceramic proportions, stone proportions, porcelain proportions, labels, residual contents, metallic constituents, and many more.

With regard to the above described method for manufacturing glass fibers, in particular ceramic, stone and porcelain proportions are problematic, for at least ferromagnetic metallic residues may largely be removed magnetically from the waste glass prior to glass melting, and labels and residual contents burn up or may be removed by washing, also prior to glass melting.

The contents of Ceramic, Stone and Porcelain in the waste glass are referred to as the CSP content.

At the currently usual dwell times of the glass in the melting tank, in particular large-sized particles of the CSP fraction are not melted entirely in producing the molten glass material, but only superficially at the edges of the individual particles.

Upon passage of a molten glass material containing CSP particles through the above described outlet orifices in the peripheral jacket of a spinner basket, the partly dissolved CSP particles may adhere in the outlet orifices to thus obstruct them. This may result on the one hand in a reduced transmissivity of the peripheral jacket of the rotating spinner basket and thus in backups in the production process, and moreover in a rotational imbalance of the rotating spinner basket, which may have an effect of reducing its service life and moreover impair operation safety. Moreover these impairments may cause problems with the fiberization process eventually leading to a degraded fiber quality and thus poorer properties of the finished products.

Accordingly, the use of waste glass other than originating from industrial wastes in the manufacture of glass wool is presently not possible, or only with major difficulties. The accumulation of non-melted CSP particles in the rotating spinner basket, together with the above mentioned consequences, has the result that in practical operation, very high demands are made to the still admissible CSP content, but wherein fundamentally a waste glass free from CSP is desired.

Thus, for example, a single “Steinhäger” liquor bottle (bottled in stone crocks) inside a collection container, corresponding to impurities in the range of several ppm's based on the total contents in the collection container, may result in a considerable disturbance of the continuous fiberization process on the production line. Possible consequences include a significant reduction of the throughput capacity as far as a premature replacement of the spinner, including an intermediate standstill of production.

Before this background, a significant utilization of waste glass, for example from communal collection containers, was out of the question.

Nowadays, however, industrial waste glasses are becoming increasingly scarce, while there is an abundance of household waste glass.

It would thus be desirable to develop a method wherein standard waste glass—as delivered by consumers to communal collection facilities—may be used for manufacturing a molten glass material for the production of mineral wool.

Starting out from the prior art described at the outset, it was therefore an object of the present invention to allow the use of relevant quantities of waste glass from communal collection facilities in the manufacture of mineral wool in accordance with the spinner basket method, so that mineral wool products thus obtained contain a high proportion of this waste glass in their composition.

This object is achieved through the characterizing features of claim 1. Preferred embodiments are represented in the further claims.

In particular, the invention relates to a method for producing a granulate from waste glass for the purposes of manufacturing mineral wool products, e.g. of biosoluble glass, obtainable with the aid of at least one spinner having the form of a spinner basket, the peripheral wall of which includes a multiplicity of small-diameter outlet orifices through which a molten glass material is spun off in the form of filaments that are subjected to a supplementary attenuating action of a downwardly directed gas flow, wherein part of the molten glass material freighted with impurities on the basis of ceramic, stone and porcelain (CSP impurities) and passing through the spinner is formed of glass material with foreign matter proportions in ground form; and

wherein the waste glass having been crushed and freed from rough impurities is ground by milling the glass materials against each other, and is sieved, so that the oversize particles occurring in sieving are furthermore ground in a cycle until even the CSP impurities have a granulometry the same as or smaller than the smallest diameter of the outlet orifices in the peripheral wall of the spinner, without the CSP impurities having to be separated out.

The invention moreover concerns the use of a waste glass granulate obtainable in accordance with a method in accordance with at least one of claims 1 to 9, for manufacturing mineral wool products obtainable with the aid of at least one spinner having the form of a spinner basket, the peripheral wall of which includes a multiplicity of small-diameter outlet orifices through which a molten glass material is spun off in the form of filaments that are subjected to a supplementary attenuating action of a downwardly directed gas flow, wherein

the waste glass granulate replaces at least part of the raw material for the molten glass material.

This small-diameter granulometry has the advantage that even not completely melted constituents of the molten glass material, such as, e.g., CSP proportions, are made up of such fine particles that they do not foul the passage openings in the spinner but are enabled to pass through them. This has the result that the transmissivity of the spinner is maintained, and backups in the production process are thereby avoided. A rotational imbalance of the spinner is moreover avoided, which has a positive effect on its service life and moreover improves operation safety.

In this respect, it shall be noted that the reduction in size of the CSP impurities used according to the invention needs only be such that the granulometry of the not completely melted constituents (such as CSP) present in the melt passing through the orifices is the same or smaller than the smallest orifice size.

There have been numerous attempts in the past to use waste glass as a recycling glass in the container glass industry, however impurities, in particular the CSP impurities, have caused great problems. On the one hand, complex CSP separators had to be installed which included, for example, an opto-electronic detection where the individual fragments are passed in front of a powerful light source and examined as to their transparency by optical sensors. Subsequently the detected particles were then ejected pneumatically. This kind of CSP separation does, however, only work with high losses of glass.

FÜHR, B. et al. in Glastech. Ber. Glass Sci. Technol. 68 (1995, No. 5), and Drescher, H. in Glasreport No. 2, Vol., 128, 1995, moreover describe a novel glass milling technique adapted to the container glass industry through differential grinding, wherein the CSP impurities are not ground but excluded from the process by sieving.

Thanks to the present invention, it is possible to substantially extend the operation life of the spinner, which has a direct effect through considerably cost savings.

Thus it is made possible by the use of a waste glass granulate or powder having a particle size distribution selected to be correspondingly small, to avoid the above described drawbacks of the use of standard waste glass in mineral wool production, which hitherto precluded the use of waste glass, and to attain the object of the invention without having to revert to separating out CSP impurities or previous separation of these admixtures.

Here particular demands are made to the grinding process. Waste glass material, in particular waste glass material having a high CSP content, may present high mechanical abrasion in the employed grinding apparatus. The desired fine grinding in particular of the CSP fraction, which is accompanied by a longer grinding time, thus inevitably results in an increased introduction of abraded material from the grinding apparatus. Problems may thus occur in grinding processes known in the prior art, as for example in the use of ball mills, the occurrence of a large quantity of abraded metal that remains in the granulate and detracts from the quality of the final product.

In a preferred embodiment, the required small granulometry of the waste glass material proportion may be provided by adjusting the granulometry sizes of the proportion of glass fragments, by grinding the glass fragments against each other, in particular by so-called glass-on-glass grinding.

The characterizing feature of glass-on-glass grinding is the absence of a dedicated grinding tool. The grinding stock of broken glass is at the same time used as a grinding tool, whereby the abrasion of foreign matter is reduced to an inevitable minimum resulting from abrasion of the wall material of the milling chamber. Hereby the non-CSP proportion of foreign matter in the molten glass material may be kept low, a high quality of the finished product may be ensured, and a suitable particle size distribution of the granulate may be achieved.

For milling the glass material proportion it is possible in principle to employ any method known in the prior art that allows to produce a broken glass granulate having a particle size suited for use in the present invention, to the extent that maximum admissible impurities of the granulate owing to abrasion of the milling bodies during the grinding process in accordance with the quality requirements to the mineral wool product are not exceeded, and the abrasion does not result in an uneconomical operation due to high maintenance and grinding tool replacement costs.

As a result of the passage of the glass fragments through the milling, optionally repeated where necessary, there results in the exemplary case an average time of milling to the desired degree of milling, of approx. between 10 and 60 min, preferably between 10 and 45 min, e.g. 15 min. This milling time period does, of course, depend on the quality of the starting material, and should insofar merely be regarded as an approximate value.

The diameters of the outlet orifices of the peripheral wall of the spinner basket are in relation with the properties of the finished mineral wool product. Fundamentally speaking, small-diameter outlet orifices allow the production of finer fibers, accordingly allowing the inclusion of more air on a mass basis, resulting in an improved insulation effect.

The combination of outlet orifices of various sizes as disclosed, e.g., in FR 2 820 736-A1, allows for the manufacture of mineral wool products containing mineral fibers of various thicknesses, which accordingly allows to combine mineral fibers of various thicknesses and having different properties in a mineral wool product.

The diameter of the passage openings in the peripheral wall of the spinner is preferably approx. 0.1-2 mm, in a particularly preferred manner approx. 0.3-1.5 mm, and in a most preferred manner approx. 0.6-1.1 mm, whereby the degree of grinding of the glass fragments is moreover determined with some tolerance due to partial softening of the outer rims of even CSP particles under the melting conditions.

A non limitative example of grinding degree suitable in the present invention, yields particles with a granulometry inferior or equal to 1.2 mm, preferably 1.1 mm.

Too large a proportion of very fine particles, much finer than the smallest outlet orifices of the spinner does not appear to be desirable, especially in view of limiting flying batch dust when charging the furnace.

By way of a non limiting example, about 40 wt % or less of the ground material would have a size smaller than 0.3 mm.

For that reason, in one preferred embodiment, granulometry of ground particles would comprise a maximum of particle size close to the outlet orifice size.

A preferred embodiment of the invention is characterized in that in particular hollow glasses containing foreign substances, such as bottles and glasses from communal collection facilities, serve as waste glass material.

The waste glass material may in particular also originate from the following glass types: flat glasses containing foreign substances, such as float glass, borosilicate glass, etc.

It is preferred to grind the waste glass material with the aid of a centrifugal or rotating mill.

The option of utilizing these glass products and waste glass products for the manufacture of mineral wool products in the process in accordance with the invention reduces the dependency on industrial waste glasses and moreover affords a considerable contribution to environmental compatibility.

Another preferred embodiment of the invention is characterized in that the proportion of the ground glass fragments in the molten glass material amounts to approx. 10 to 90%, especially approx. 10 to 80%, preferably approx. 30 to 75%.

It may also be preferred for the molten glass material to contain a proportion of ground glass fragments and a proportion of glass fragments free from foreign substances, such as flat glass.

Here the skilled person will be aware that the specific features of the single embodiments may arbitrarily be combined for attaining the object of the invention, without departing from the scope of the present invention.

Further advantages and features of the present invention result from the description of an embodiment and by reference to the drawings, wherein:

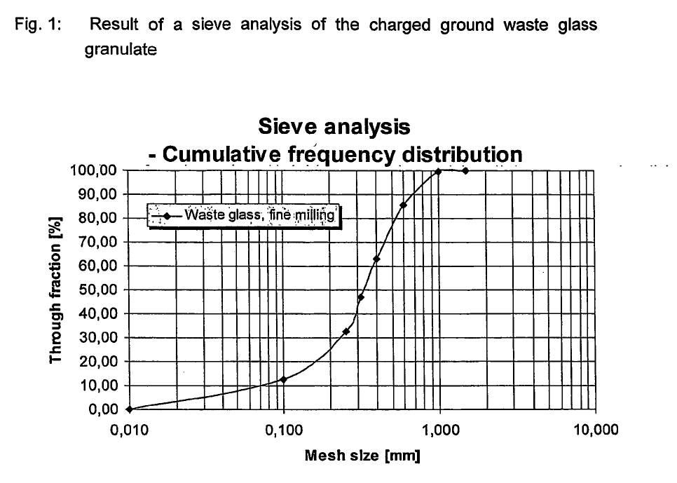

FIG. 1 shows the result of a sieve analysis of the charged ground waste glass granulate as a diagrammatic representation of the sieve through fraction as a function of the mesh size of the sieve.

The method for manufacturing glass wool encompasses a melting furnace into which the raw materials required for the mineral wool production and containing the ground waste glass granulate are introduced.

These raw materials consist of 750 kg of waste glass from collection containers, freed from rough impurities in accordance with techniques known in the prior art, and ground in a glass-on-glass grinding process with glass fragments as milling bodies until the resulting granulate has a particle size distribution about corresponding to the one represented in Table 1 in connection with FIG. 1.

Glass-on-glass grinding of the glass fragments is carried out by the “GlassMax Grinder” of the company REMco. This is a centrifugal or rotating mill known from rock processing technology. The stock crushed in advance, the glass fragments, impact on a horizontally positioned milling rotor which accelerates the stock within a minimum distance to velocities of 40-50 m/s, corresponding to an acceleration of up to 1.900 g. Outside of the milling rotor the particles are flung into an impact chamber consisting of segment chambers filled with material.

The grinding process thus essentially unfolds as a two-stage process with rough milling and subsequent fine grinding. Rough milling results from the impact of the grinding stock on the rotor in the impact chambers and in the reduction of the kinetic energy. The subsequent fine grinding results from the friction and rolling of the pre-ground particles in the rotor upon acceleration of the material. From the mill, the material is conveyed across a sieving means. The latter sieves from the grinding stock the granulate, which is supplied via an intermediate storage to the mixture of raw materials. The rest of the grinding stock, the so-called oversize particles making up a mass proportion of approx. 60%, is resupplied to the mill together with fresh grinding stock. As a result of the passage of the glass fragments through the milling, optionally repeated where necessary, there results in the exemplary case an average time of milling to the desired degree of milling, of approx. 15 min. This time period does, of course, depend on the quality of the starting material, and should insofar merely be regarded as an approximate value.

In order to reduce the introduction of metal from abrasion during the grinding process, the wall of the “GlassMax Grinder” consists of a metal-free lining of ceramic material.

This resulting granulate is subsequently mixed with 250 kg of a mixture of raw materials as usual for manufacturing glass and comprised of sand, dolomite, soda, borates, etc.

By heating to approx. 1400° C. the starting materials are transformed into the molten glass material.

In order to oxidize the organic foreign substances, MnO₂ in the form of manganese dioxide is added into the melting tank as an oxidant.

The molten glass material is supplied to a spinner via a feeder.

This spinner basket rotates about the axis of the impinging jet of molten material while being driven at approx. 3,000 rpm. The peripheral wall of the spinner includes passage openings, wherein in the bottom third of the peripheral wall 50% of the orifices, each having a diameter of 0.7 mm, are arranged, in the center third 30% of the orifices each having a diameter of 0.8 mm are arranged, and in the top third the remaining 20% of the passage openings each having a diameter of 0.9 mm are arranged. The molten glass material is now pressed through these passage openings. Primary filaments are formed which are further elongated due to the attenuating action of a downwardly directed gas flow, so that finished glass fibers form the inventive glass wool product, which is characterized in that it consists of a 75-% waste glass content, was produced in an energy-saving way, and moreover, thanks to a high proportion of particularly fine fibers, possesses excellent heat insulation properties.

FIG. 1 represents the result of a sieve analysis performed for the ground waste glass granulate that was charged as a raw material in one embodiment.

Waste glass material having glass fragment sizes of, e.g., 0-80 mm for standard broken glass and 0-30 mm for flat glass fragments, were milled in a glass-on-glass grinding process by the REMco “GlassMax Grinder” with broken glass as milling bodies, until the consistency of the resulting granulate appeared suitable for use as a raw material for manufacturing mineral fibers. The sieve analysis of the granulate was determined in the exemplary case in analogy with DIN 66165. The obtained results are represented in Table 1.

TABLE 1
Results of the sieve analysis of the waste glass
granulate based on 100 g of waste glass granulate

| | Residue on | Proportion based on | Sieve through |
|---|---|---|---|
| Sieve | sieve | originally weighted quantity | fraction |
| [mm] | [g] | [%] | [%] |
| 1.500 | 0 | 0.0 | 100.00 |
| 1.000 | 0.5 | 0.3 | 99.75 |
| 0.600 | 28.5 | 14.3 | 85.50 |
| 0.400 | 45 | 22.5 | 63.00 |
| 0.315 | 32 | 16.0 | 47.00 |
| 0.250 | 29 | 14.5 | 32.50 |
| 0.100 | 40 | 20.0 | 12.50 |
| 0 | 25 | 12.5 | 0 |
| | 200 | 100 | |

It is clearly visible from the results represented in the Table in conjunction with the diagrammatic representation of the results of the sieve analysis in FIG. 1 that the exemplarily explained glass-on-glass grinding process is well suited for the production of a granulate having a sufficiently small particle size to be suited for use in the present invention.

1. A method for producing a granulate from waste glass for the purposes of manufacturing mineral wool products obtainable with the aid of at least one spinner having the form of a spinner basket, the peripheral wall of which includes a multiplicity of small-diameter outlet orifices through which a molten glass material is spun off in the form of filaments that are subjected to a supplementary attenuating action of a downwardly directed gas flow, wherein part of the molten glass material freighted with impurities on the basis of ceramic, stone and porcelain (CSP impurities) and passing through the spinner basket is formed of glass material with foreign matter proportions in ground form;
wherein the waste glass having been crushed and freed from rough impurities is ground by milling the glass materials against each other, and sieved, so that the oversize particles occurring in sieving are furthermore milled in a cycle until even the CSF impurities have a granulometry the same as or smaller than the smallest diameter of the outlet orifices in the peripheral wall of the spinner, without the CSF impurities having to be separated out,
wherein the process has the form of a glass-on-glass grinding process; and
wherein the granulometry of the ground waste glasses including CSP impurities corresponding to the diameter of the outlet orifices in the peripheral wall of the spinner is approx. 0.1-2 mm.

2. The process according to claim 1, wherein the granulometry is approx. 0.3-1.5 mm, and preferably approx. 0.6-1.1 mm.

3. The process according claim 1, wherein the process is a two-stage grinding process including a first rough grinding stage and a second fine grinding stage.

4. The process according to claim 1, wherein the glass material, in particular glass fragments, impacts inside the mill on a horizontally positioned milling rotor that accelerates the broken glass to velocities of approx. 40-50 m/s;
the formed particles are flung outside the milling rotor into an impact chamber to be further comminuted by the impact on already existing grinding stock;
finely ground waste glass is sieved out; and the occurring oversize particles of glass and CSP impurities are resupplied to the mill together with fresh grinding stock.

5. The process according to claim 1, wherein a centrifugal or rotating mill is used as the mill.

6. The process according to claim 4, wherein the impact chamber also contains waste glass material.

7. The process according to claim 1, wherein in particular hollow glasses containing foreign substances, such as bottles and glasses from communal collection facilities, serve as waste glass material.

8. The process according to claim 1, wherein in particular fiat glasses containing foreign substances, such as float glass, borosilicate glass, etc. serve as waste glass.

9. A method for manufacturing mineral wool products, said method comprising first obtaining a waste glass granulate obtainable in accordance with a method according to claim 1, for manufacturing mineral wool products obtainable with the aid of at least one spinner having the form of a spinner basket, the peripheral wall of which includes a multiplicity of small-diameter outlet orifices through which a molten glass material is spun off in the form of filaments that are subjected to a supplementary attenuating action of a downwardly directed gas flow, wherein the waste glass granulate replaces at least part of the raw material for the molten glass material, wherein the granulometry of the waste glass granulate corresponding to the diameter of the outlet orifices in the peripheral wall of the spinner is approx. 0.1-2 mm.

10. The method according to claim 9, wherein the granulometry is approx. 0.3-1.5 mm, and preferably approx. 0.6-1.1 mm.

11. The method according to claim 9, wherein the proportion of the waste glass granulate is approx. 10 to 90%, especially 10 to 80% (wt.), preferably approx. 30 to 75% (wt.).

12. The method according to claim 9, wherein the molten glass material contains a proportion of waste glass granulate from communal collection facilities and a proportion of waste glass free from foreign substances, in particular flat glass.

13. The method in accordance with claim 10, wherein the molten glass material contains a proportion of waste glass granulate from communal collection facilities and a proportion of waste glass free from foreign substances, in particular flat glass.

14. Waste glass granulate obtainable in accordance with claim 1, suitable for use in manufacturing mineral wool products obtainable with the aid of at least one spinner having the form of a spinner basket, the peripheral wall of which includes a multiplicity of small-diameter outlet orifices through which a molten glass material is spun off in the form of filaments that are subjected to a supplementary attenuating action of a downwardly directed gas flow, wherein the granulometry of the granulate is inferior or equal to 1.2 mm, especially 1.1 mm, preferably not greater than 0.6 to 1.1 mm.
